(19) United States
(12) Patent Application Publication
(10) Pub. No.: US 2022/0327408 A1
(43) Pub. Date: Oct. 13, 2022

(54) SYSTEM AND METHOD FOR PROBABILISTIC FORECASTING USING MACHINE LEARNING WITH A REJECT OPTION

(71) Applicant: ROYAL BANK OF CANADA, Toronto (CA)

(72) Inventors: Lili MENG, Vancouver (CA); Xiaobin Chang, Guangzhou (CN); Gregory Mori, Vancouver (CA); Frederick Tung, Vancouver (CA)

(21) Appl. No.: 17/715,608

(22) Filed: Apr. 7, 2022

Related U.S. Application Data
(60) Provisional application No. 63/171,862, filed on Apr. 7, 2021.

(51) Int. Cl. G06N 7/00; G06N 3/08

(52) U.S. Cl. CPC G06N 7/005; G06N 3/08

(57) ABSTRACT

A computer-implemented system and method for training a machine learning model are disclosed, the method includes: maintaining a data set representing a neural network having a plurality of weights; receiving input data comprising a plurality of time series data sets ending with timestamp t−1; generating, using the neural network and based on the input data, a probabilistic forecast distribution prediction at timestamp t and a selection value associated with the probabilistic forecast distribution prediction at timestamp t; computing a loss function based on the selection value; and updating at least one of the plurality of weights of the neural network based on the loss function.

### CROSS REFERENCE TO RELATED APPLICATION

This patent application claims priority to and benefit of U.S. provisional patent application No. 63/171,862 filed on Apr. 7, 2021, the entire content of which is herein incorporated by reference.

### FIELD

Embodiments of this disclosure relate to implementing machine learning models to predict probability distribution for various practical applications, and in particular, some embodiments relate to implementing machine learning models for probabilistic forecasting.

### BACKGROUND

In some applications of machine learning models, range predictions and probabilistic forecasting can be a useful alternative to simple point predictions. However, in some scenarios, inaccurate predictions and uncertainties can have harmful downstream consequences.

### SUMMARY

According to an aspect of the present disclosure, there is provided a computer-implemented system for training a neural network for probabilistic forecasting, the system may include: bat least one processor; memory in communication with the at least one processor; instructions stored in the memory, which when executed at the at least one processor causes the system to: maintain a data set representing a neural network having a plurality of weights; receive input data comprising a plurality of time series data sets ending with timestamp t−1; generate, using the neural network and based on the input data, a probabilistic forecast distribution prediction at timestamp t and a selection value associated with the probabilistic forecast distribution prediction at timestamp t; compute a loss function based on the selection value; and update at least one of the plurality of weights of the neural network based on the loss function.

In some embodiments, the probabilistic forecast distribution prediction at timestamp t may include a mean and a variance of the probabilistic forecast distribution prediction.

In some embodiments, the instructions when executed at the at least one processor causes the system to: when the selection value is higher than or equal to a threshold value, store the probabilistic forecast distribution prediction at timestamp t as a valid prediction.

In some embodiments, the instructions when executed at the at least one processor causes the system to: process the stored probabilistic forecast distribution prediction at timestamp t to generate a predicted electricity consumption report.

In some embodiments, the instructions when executed at the at least one processor causes the system to: process the stored probabilistic forecast distribution prediction at timestamp t to generate a future financial forecasting statement.

In some embodiments, the instructions when executed at the at least one processor causes the system to: when the selection value is lower than a threshold value, reject the probabilistic forecast distribution prediction at timestamp t.

In some embodiments, the instructions when executed at the at least one processor causes the system to: generate a signal for causing, at a display device, a display of a graphical user interface showing that the probabilistic forecast distribution prediction at timestamp t has been rejected.

In some embodiments, the instructions when executed at the at least one processor causes the system to: generate a second signal for causing, at the display device, a display of a graphical user interface showing the threshold value.

In some embodiments, the instructions when executed at the at least one processor causes the system to: generate a third signal for causing, at the display device, a display of a graphical user interface showing a graphical user element for modifying the threshold value.

In some embodiments, the neural network comprises a recurrent neural network (RNN) represented by Φ based on:

m_{i,t+1},v_{i,t+1},s_{i,t+1},h_{i,t+1}=Φ(m_{i,t},h_{i,t};θ), wherein:

m_{i,t+1} represents a mean value of the probabilistic forecast distribution prediction at timestamp t+1 for the ith sample;

v_{i,t+1} represents a variance v_{i,t+1} of the probabilistic forecast distribution prediction at timestamp t+1 for the ith sample;

s_{i,t+1} represents the selection value associated with the probabilistic forecast distribution prediction at timestamp t+1 for the ith sample;

m_{i,t} represents a mean value of a probabilistic forecast distribution prediction at timestamp t for the ith sample;

θ represents one or more learnable model parameters for the recurrent neural network;

h_{i,t} represents a hidden state vector at timestamp t for the ith sample; and

h_{i,t+1} represents a hidden state vector at timestamp t+1 for the ith sample.

According to another aspect of the present disclosure, there is provided a computer-implemented method for training a neural network for probabilistic forecasting, the method may include: maintaining a data set representing a neural network having a plurality of weights; receiving input data comprising a plurality of time series data sets ending with timestamp t−1; generating, using the neural network and based on the input data, a probabilistic forecast distribution prediction at timestamp t and a selection value associated with the probabilistic forecast distribution prediction at timestamp t; computing a loss function based on the selection value; and updating at least one of the plurality of weights of the neural network based on the loss function.

In some embodiments, the probabilistic forecast distribution prediction at timestamp t may include a mean and a variance of the probabilistic forecast distribution prediction.

In some embodiments, the method may include: when the selection value is higher than or equal to a threshold value, storing the probabilistic forecast distribution prediction at timestamp t as a valid prediction.

In some embodiments, the method may include: processing the stored probabilistic forecast distribution prediction at timestamp t to generate a predicted electricity consumption report.

In some embodiments, the method may include: processing the stored probabilistic forecast distribution prediction at timestamp t to generate a future financial forecasting statement.

In some embodiments, the method may include: when the selection value is lower than a threshold value, rejecting the probabilistic forecast distribution prediction at timestamp t.

In some embodiments, the method may include: generating a signal for causing, at a display device, a display of a graphical user interface showing that the probabilistic forecast distribution prediction at timestamp t has been rejected.

In some embodiments, the method may include: generating a second signal for causing, at the display device, a display of a graphical user interface showing the threshold value and a graphical user element for modifying the threshold value.

In some embodiments, the neural network may be a recurrent neural network (RNN) represented by Φ based on:

m_{i,t+1},v_{i,t+1},s_{i,t+1},h_{i,t+1}=Φ(m_{i,t},h_{i,t};θ), wherein:

m_{i,t+1} represents a mean value of the probabilistic forecast distribution prediction at timestamp t+1 for the ith sample;

v_{i,t+1} represents a variance v_{i,t+1} of the probabilistic forecast distribution prediction at timestamp t+1 for the ith sample;

s_{i,t+1} represents the selection value associated with the probabilistic forecast distribution prediction at timestamp t+1 for the ith sample;

m_{i,t} represents a mean value of a probabilistic forecast distribution prediction at timestamp t for the ith sample;

θ represents one or more learnable model parameters for the recurrent neural network;

h_{i,t} represents a hidden state vector at timestamp t for the ith sample; and

h_{i,t+1} represents a hidden state vector at timestamp t+1 for the ith sample.

According to yet another aspect of the present disclosure, there is provided a non-transitory computer readable memory having stored thereon a data set representing a neural network and instructions for training the neural network, the instructions, when executed at the at least one processor, causes a system having the at least one processor to: maintain the data set representing the neural network having a plurality of weights; receive input data comprising a plurality of time series data sets ending with timestamp t−1; generate, using the neural network and based on the input data, a probabilistic forecast distribution prediction at timestamp t and a selection value associated with the probabilistic forecast distribution prediction at timestamp t; compute a loss function based on the selection value; and update at least one of the plurality of weights of the neural network based on the loss function.

According to an aspect of the present disclosure, there is provided a computer-implemented method for a range-based machine learning architecture. The method includes: with input data including a plurality of series of data values, training a machine learning model to generate a forecast probability distribution and a select/reject value, wherein predictions with a select/reject value below a threshold are rejected; and storing a data set and/or instructions representing the trained machine learning model in a computer-readable memory.

According to another aspect, there is provided a device or system comprising: at least one memory for storing trained machine learning model and at least one processor. The at least one processor configured to: with input data including a plurality of series of data values, train a machine learning model to generate a forecast probability distribution and a select/reject value, wherein predictions with a select/reject value below a threshold are rejected; and store a data set and/or instructions representing the trained machine learning model in a computer-readable memory.

A non-transitory computer readable memory having stored thereon data and/or instructions representing a machine learning model trained to generate a forecast probability distribution and a select/reject value, wherein predictions with a select/reject value below a threshold are rejected. The machine learning model, when instantiated by at least one processor, configured to receive input query data to generate a forecast prediction and an associated select/reject value.

Other features will become apparent from the drawings in conjunction with the following description.

### BRIEF DESCRIPTION OF DRAWINGS

In the figures which illustrate example embodiments,

FIG. 1 is a schematic diagram of a computer-implemented system for training a neural network for probabilistic forecasting, in accordance with an embodiment;

FIG. 2A is a schematic diagram of an machine learning agent of the system of FIG. 1, in accordance with an embodiment;

FIG. 2B is a schematic diagram of an example neural network, in accordance with an embodiment;

FIG. 3 is an illustration of an example recurrent neural network model for probabilistic forecasting in auto-regressive (AR) style.

FIG. 4 is a block diagram showing aspects of example hardware components of a computing device for a range-based machine learning architecture;

FIG. 5 is a flowchart showing aspects of an example process for a range-based machine learning architecture; and

FIG. 6 is a flowchart showing aspects of an example process for training a neural network for probabilistic forecasting.

### DETAILED DESCRIPTION

In some forecasting applications associated with a high degree of uncertainty, a range prediction can be desired from the forecasting model. A probabilistic forecasting neural network model can be configured to output a probability distribution, allowing the model to capture spread or multi-modal characteristics in the data that would be lost with a simple point prediction. However, when the model is extremely uncertain about its prediction, for example due to the uniqueness of the input with respect to previously observed training examples, it may be preferable for the model to abstain from making a prediction at all, instead of making a very poor prediction with potentially harmful downstream consequences.

When operating in highly uncertain environments, how to train a probabilistic forecasting model with a reject option can be a challenge.

One approach would be to threshold the spread of the predictive distribution as a post-processing rule. However, a post-processing approach can be sub-optimal because the reject option is not taken into consideration during training.

In accordance with aspects of the present application, an example end-to-end machine learning probabilistic forecasting model that integrates a selection/reject option during training is described herein. In some scenarios, by incorporating the selection/reject option during training, the proposed approach may avoid unnecessarily dedicating optimization resources to fitting highly uncertain parts of the input space, as the highly uncertain inputs would likely be rejected anyway.

Unlike a conventional regression model that outputs a single point estimate, a probabilistic forecasting model outputs a probability distribution. For example, probabilistic forecasting is a technique commonly used for weather forecasting to establish an event occurrence or magnitude probability. This differs substantially from giving a definite information on the occurrence/magnitude (or not) of the same event, technique used in deterministic forecasting. In some applications, probabilistic forecasting enables a richer representation of the data for downstream applications (e.g. a distribution can capture “spread” or multi-modal characteristics in the data that would be lost with a point estimate).

In some embodiments, an example system (DeepAR) can be based on training an auto-regressive recurrent neural network (RNN) model on a large number of related time series. In another example, a model DeepState can combine a traditional state-space model with RNNs. This model parameterizes a per-time-series linear state space model with a jointly-learned RNN. In another example, a Probabilistic TCN model presents a probabilistic convents to estimate probability density under both parametric and non-parametric settings. In another example, a Stochastic TCN model combines the computational advantages of TCN with the representational power of stochastic latent spaces.

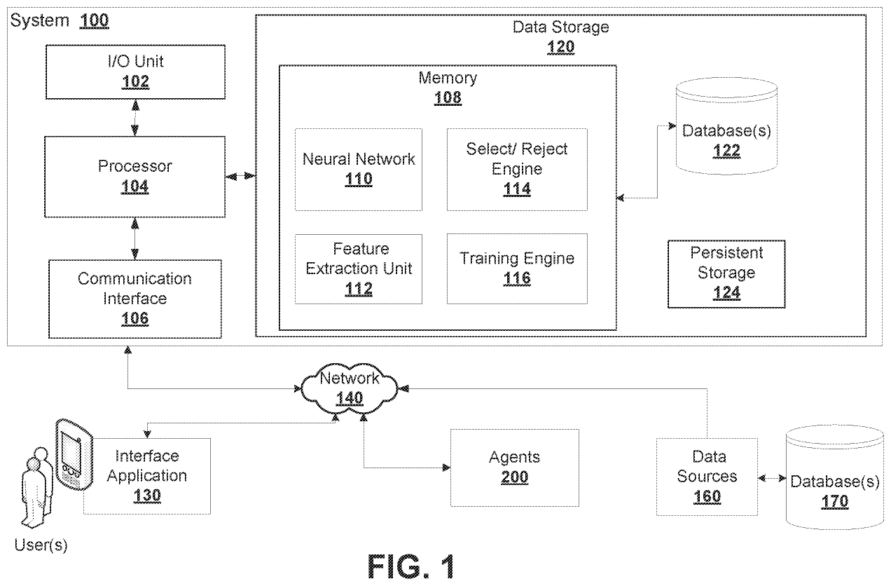

FIG. 1 is a high-level schematic diagram of a computer-implemented system 100 for instantiating and training machine learning agents 200 having a machine learning neural network, in accordance with an embodiment. A machine learning agent 200 can be an automated agent 200 that leverages a neural network 110 to perform actions based on input data. The neural network 110 may be a RNN, such as a long short-term memory (LSTM) or gated recurrent units (GRU).

In various embodiments, system 100 is adapted to perform certain specialized purposes. In some embodiments, system 100 is adapted to instantiate and train automated agents 200 for generating valid probability distribution data forecasts for downstream processing. Probability distribution data may include a range, that is, a probability value may be assigned for each of a plurality of outcomes. The plurality of outcomes may be associated with one or more timestamps.

As will be appreciated, system 100 is adaptable to instantiate and train automated agents 200 for a wide range of purposes and to complete a wide range of tasks. For example, automated agent 200 may generate probability distribution forecasts for predicting future electricity usage and consumption during a future time frame. In other embodiments, system 100 is adapted to instantiate and train automated agents 200 for predicting financial statements or financial spending amounts in a future time period for a particular user.

Once an automated agent 200 has been trained, it generates output data reflective of its decisions to take particular actions in response to particular input data. Input data include, for example, values of a plurality of state variables relating to an environment being explored by an automated agent 200 or a task being performed by an automated agent 200. In some embodiments, input data may include a time series data.

### Probability Distribution for Electricity Consumption

In some embodiments, input data may include time series data sets representing historical data on electricity consumption for a user or an area. The time series data sets may be used, by a training engine 116 to train a neural network 110. The training engine 116 may receive signal representing a selection value from a select/reject engine 114, which computes the selection value based on a number of parameters associated with the neural network 110. The training engine 116 may compute a loss function based on the selection value, and update weights of the neural network 110 based on the loss function.

Once properly trained, the neural network 110 may be used by agent 200 to generate probability distribution prediction for electricity consumption for the same user or the same area at a particular future timestamp relative to the historical data. The probability distribution prediction at the future timestamp may be associated with a selection value, which may be used to evaluate the probability distribution prediction.

When the selection value is beneath a certain predetermined threshold, the probability distribution prediction may be rejected. On the contrary, when the selection value is above or equal to a certain predetermined threshold, the probability distribution prediction may be selected and stored as valid data set.

In some embodiments, if the probability distribution prediction is rejected, agent 200 may generate signals to display a graphical user interface (GUI), at a display device (e.g., at an interface application 130 at user device), indicating that the generated probability distribution prediction for the particular future timestamp is rejected. In some embodiments, agent 200 may generate a further signal to, at the display device (e.g., at an interface application 130 at user device), a GUI showing the threshold used in rejecting the probability distribution prediction for the particular future timestamp, and may optionally generate another signal for displaying a graphical user element for modifying the threshold.

When the selection value is above or equal to the predetermined threshold, the probability distribution prediction may be selected and stored as valid data set. In the case of electricity consumption report at the future timestamp, the probability distribution prediction may be used to determine a future pricing for electricity for one or more users in an area.

### Probability Distribution for Weather Forecasting

In some embodiments, input data may include time series data sets representing historical data on weather patterns, such as rain accumulation, for a certain area. The time series data sets may be used, by a training engine 116 to train a neural network 110. The training engine 116 may receive signal representing a selection value from a select/reject engine 114, which computes the selection value based on a number of parameters associated with the neural network 110. The training engine 116 may compute a loss function based on the selection value, and update weights of the neural network 110 based on the loss function.

Once properly trained, the neural network 110 may be used by agent 200 to generate probability distribution prediction for rain accumulation for the same area at a particular future timestamp (e.g., “15+/−10 mm of rain is forecasted for New York next Wednesday”). The probability distribution prediction at the future timestamp may be associated with a selection value, which may be used to evaluate the probability distribution prediction.

When the selection value is beneath a certain predetermined threshold, the probability distribution prediction may be rejected. On the contrary, when the selection value is above or equal to a certain predetermined threshold, the probability distribution prediction may be selected and stored as valid data set.

In some embodiments, if the probability distribution prediction is rejected, agent 200 may generate signals to display a graphical user interface (GUI), at a display device (e.g., at an interface application 130 at user device), indicating that the generated probability distribution prediction for the particular future timestamp is rejected. In some embodiments, agent 200 may generate a further signal to, at the display device (e.g., at an interface application 130 at user device), a GUI showing the threshold used in rejecting the probability distribution prediction for the particular future timestamp, and may optionally generate another signal for displaying a graphical user element for modifying the threshold.

When the selection value is above or equal to the predetermined threshold, the probability distribution prediction may be selected and stored as valid data set. In the case of predicting rain accumulation for a certain area, the probability distribution prediction may be processed to generate weather forecast for a future time period, which may include prediction of rain accumulation and other weather patterns on one or more days in the future time period.

### Probability Distribution for Financial Reporting

In some embodiments, input data may include time series data sets representing historical data on financial statements, such as utility bills, for a user. The time series data sets may be used, by a training engine 116 to train a neural network 110. The training engine 116 may receive signal representing a selection value from a select/reject engine 114, which computes the selection value based on a number of parameters associated with the neural network 110. The training engine 116 may compute a loss function based on the selection value, and update weights of the neural network 110 based on the loss function.

Once properly trained, the neural network 110 may be used by agent 200 to generate a probability distribution for predicting a financial statement or utility amount for the user in a future time frame (e.g., “there is a probability of 80% of your utility bill being in the range of 80-100 USD for next month.”). The probability distribution prediction at the future timestamp may be associated with a selection value, which may be used to evaluate the probability distribution prediction.

When the selection value is beneath a certain predetermined threshold, the probability distribution prediction may be rejected. On the contrary, when the selection value is above or equal to a certain predetermined threshold, the probability distribution prediction may be selected and stored as valid data set.

In some embodiments, if the probability distribution prediction is rejected, agent 200 may generate signals to display a graphical user interface (GUI), at a display device (e.g., at an interface application 130 at user device), indicating that the generated probability distribution prediction for the particular future timestamp is rejected. In some embodiments, agent 200 may generate a further signal to, at the display device (e.g., at an interface application 130 at user device), a GUI showing the threshold used in rejecting the probability distribution prediction for the particular future timestamp, and may optionally generate another signal for displaying a graphical user element for modifying the threshold.

When the selection value is above or equal to the predetermined threshold, the probability distribution prediction may be selected and stored as valid data set. For example, the probability distribution prediction may be processed to generate a predicted financial spending of a certain category, or an overall financial overview, of the user at a future time frame, and the user may be prompted notified, via a generated signal at a user device, regarding his or her predicted financial bill (e.g., an estimated utility bill amount).

Referring back to FIG. 1, System 100 includes an I/O unit 102, a processor 104, a communication interface 106, and a data storage 120.

I/O unit 102 enables system 100 to interconnect with one or more input devices, such as a keyboard, mouse, camera, touch screen and a microphone, and/or with one or more output devices such as a display screen and a speaker.

Processor 104 executes instructions stored in memory 108 to implement aspects of processes described herein. For example, processor 104 may execute instructions in memory 108 to configure a data collection unit, interface unit (to provide control commands to interface application 130), machine learning network 110, feature extraction unit 112, reject engine 114, training engine 116 and other functions described herein. Processor 104 can be, for example, various types of general-purpose microprocessor or microcontroller, a digital signal processing (DSP) processor, an integrated circuit, a field programmable gate array (FPGA), a reconfigurable processor, or any combination thereof.

Communication interface 106 enables system 100 to communicate with other components, to exchange data with other components, to access and connect to network resources, to serve applications, and perform other computing applications by connecting to a network 140 (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi or WiMAX), SS7 signaling network, fixed line, local area network, wide area network, and others, including any combination of these.

Data storage 120 can include memory 108, databases 122, and persistent storage 124. Data storage 120 may be configured to store information associated with or created by the components in memory 108 and may also include machine executable instructions. Persistent storage 124 implements one or more of various types of storage technologies, such as solid state drives, hard disk drives, flash memory, and may be stored in various formats, such as relational databases, non-relational databases, flat files, spreadsheets, extended markup files, etc.

Data storage 120 stores a model for a machine learning neural network. The neural network is used by system 100 to instantiate one or more automated agents 200 that each maintain a neural network 110 (which may also be referred to as a machine learning network 100 or a network 110 for convenience). Automated agents 200 may be referred to herein as machine learning agents, and each automated agent may be referred to herein as a machine learning agent.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

System 100 may connect to an interface application 130 installed on a user device to receive input data. The interface unit 130 interacts with the system 100 to exchange data (including control commands) and generates visual elements for display at the user device. The visual elements can represent machine learning networks 110 and output generated by machine learning networks 110.

System 100 may be operable to register and authenticate users (using a login, unique identifier, and password for example) prior to providing access to applications, a local network, network resources, other networks and network security devices.

System 100 may connect to different data sources 160 and databases 170 to store and retrieve input data and output data.

Processor 104 is configured to execute machine executable instructions (which may be stored in memory 108) to instantiate an automated agent 200 that maintains a neural network 110, and to train neural network 110 of automated agent 200 using training engine 116. Training engine 116 may implement various machine learning algorithms, such as RNN, LSTM or GRU.

Processor 104 is configured to execute machine-executable instructions (which may be stored in memory 108) to train a neural network 110 using a loss function, as described in detail below. A trained neural network 110 may be provisioned to one or more automated agents 200.

In some embodiments, aspects of system 100 are further described with an example embodiment in which system 100 is configured to function as a trading platform. In such embodiments, automated agent 200 may generate requests for to be performed in relation to securities, e.g., requests to trade, buy and/or sell securities.

Feature extraction unit 112 can be configured to process input data to compute a variety of features. The input data can represent a trade order. Example features include pricing features, volume features, time features, Volume Weighted Average Price features, and market spread features.

In some embodiments, system 100 may process trade orders using the machine learning network 110, which may be a reinforcement learning network 110, in response to requests from an automated agent 200.

Some embodiments can be configured to function as a trading platform. In such embodiments, an automated agent 200 may generate requests to be performed in relation to securities, e.g., requests to trade, buy and/or sell securities.

Example embodiments can provide users with visually rich, contextualized explanations of the behaviour of an automated agent 200, where such behaviour includes requests generated by automated agents 200, decision made by automated agent 200, recommendations made by automated agent 200, or other actions taken by automated agent 200. Insights may be generated upon processing data reflective of, for example, market conditions, changes in policy of an automated agent 200, data outputted by scorer 308 describing the relative importance of certain factors or certain state variables.

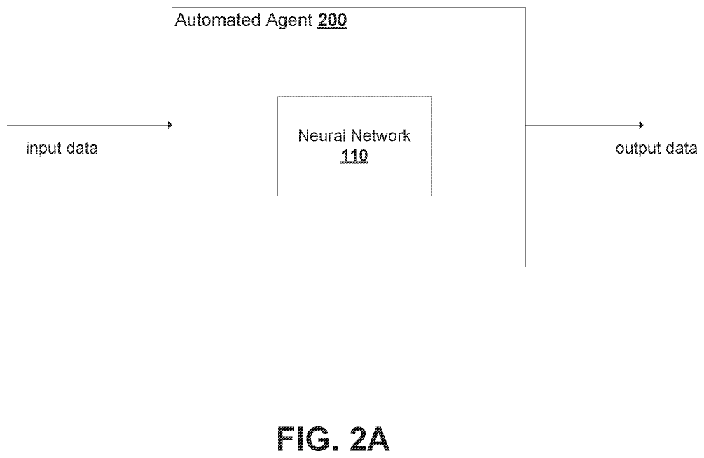

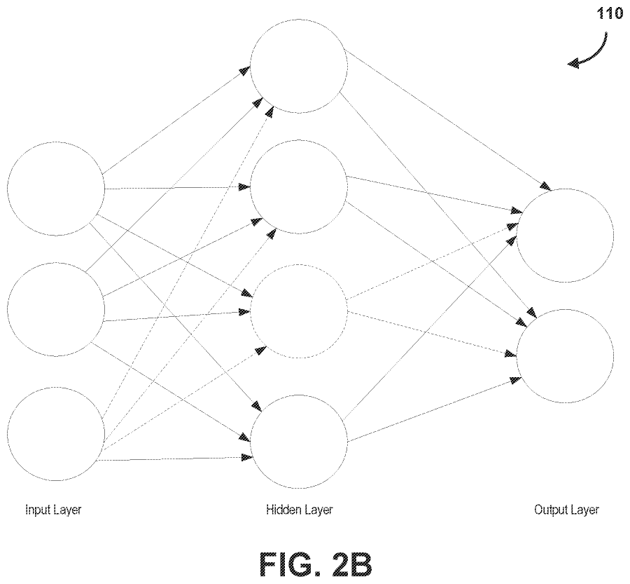

As depicted in FIG. 2A, automated agent 200 receives input data (via a data collection unit, not shown) and generates output data according to its machine learning network 110. Automated agents 200 may interact with system 100 to receive input data and provide output data.

FIG. 2B is a schematic diagram of an example neural network 110, in accordance with an embodiment. The example neural network 110 can include an input layer, a hidden layer, and an output layer. The neural network 110 processes input data using its layers based on machine learning, for example.

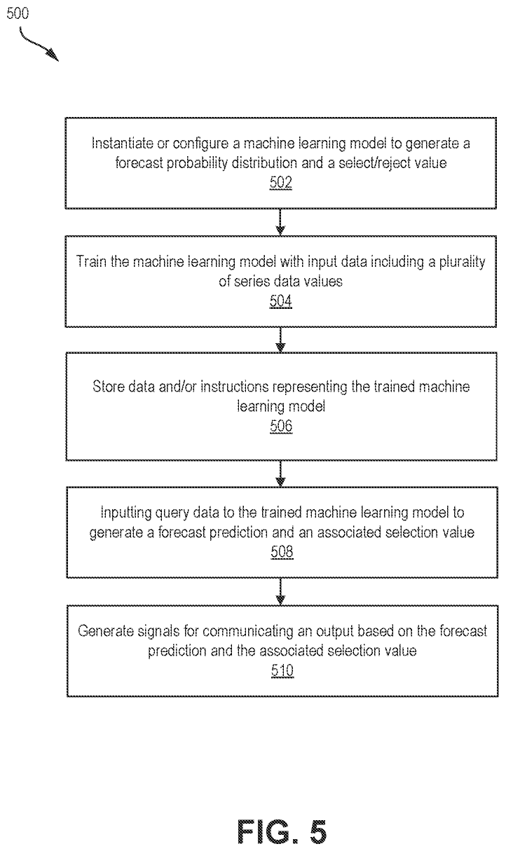

FIG. 5 is a flowchart showing aspects of an example process 500 for a range-based machine learning architecture, as performed by system 100 in some embodiments. The steps are provided for illustrative purposes. Variations of the steps, omission or substitution of various steps, or additional steps may be considered. It should be understood that one or more of the blocks may be performed in a different sequence or in an interleaved or iterative manner.

At 502, the processor 104 instantiates, loads, configures or otherwise generates a machine learning model. The machine learning model is configured to generate probability distribution data, and a select/reject value. The select/reject value may also be referred to as a selection value throughout this disclosure.

In some embodiments, the machine learning model 110 is a probabilistic forecasting model. In some embodiments, the machine learning model 110 generates a select/reject value associated with a prediction. In some configurations, a prediction with a select/reject value below a threshold can be rejected or otherwise not relied upon in downstream applications or as a usable output.

In some embodiments, the neural network model 110 can be configured and implemented based on the following.

Let [symbol] ={Yᵢ}ᵢ₌₁^{N} denote a data set containing N different time series. The N different time series may contain data of the same type. For example, each of the N different time series may include, respectively, a time series data on historical electricity consumption data for a user or an area.

The temporal length of each sample in the N different time series is the same and denoted as T. Therefore, Yᵢ∈ [symbol] ^{1×T}. By expressing Yᵢ as

Yᵢ=y_{i,1:T}, (1)

the sub-sequences of Yᵢ can be easily located. For example, the data of the ith sample between t₁ and t₂ (t₁<t₂) can be represented as y_{i,t}_{₁}_{:t}_{₂}. The data point at a time step t is simplified as y_{i,t}∈ [symbol] . Each sample Yᵢ is further divided into two non-overlapping sub-series: the context series Yᵢ^{c}∈ [symbol] ^{1×T}^{^{c}} and the forecast sequence Yᵢ^{f}∈ [symbol] ^{1×T}^{^{f}}. Specifically,

Yᵢ=[Yᵢ^{c},Yᵢ^{f}], (2)

where Yᵢ^{c}=y_{i,1:T}_{^{c}} and Yᵢ^{f}=y_{i,T}_{^{c}}_{+1:T} with T=T^{C}+T^{f}.

Given the context Yᵢ^{c}, time series forecasting aims to predict the values at future time steps and Yᵢ^{f} serves as the ground-truth of such predictions. Instead of predicting the exact value at each time step of Yᵢ^{f}, the neural network 110 may implement the probabilistic forecasting to estimate the likelihoods of the forecast values.

In some embodiments, the learning objective of probabilistic time series forecast can be expressed as a conditional likelihood,

p(Yᵢ^{f}|Yᵢ^{c};Φ), (3)

where Φ is a sequential model for neural network 110, i.e., GRU, with learnable model parameters θ. p is the likelihood value function of a predefined distribution [symbol] , e.g., Gaussian or Laplacian. For the ith training sample, the distribution parameters, e.g., mean m_{i,t+1} and variance v_{i,t+1}, of the prediction at t+1 is provided by Φ with previous output m_{i,t} as input.

The recurrent model Φ is thus implemented in auto regressive (AR) for prediction,

m_{i,t+1},v_{i,t+1},h_{i,t+1}=Φ(m_{i,t},h_{i,t};θ), (4)

t∈{1, . . . , T^{f}}. Initial m_{i,1} and h_{i,t} are computed by Φ with the context Yᵢ^{c} as input.

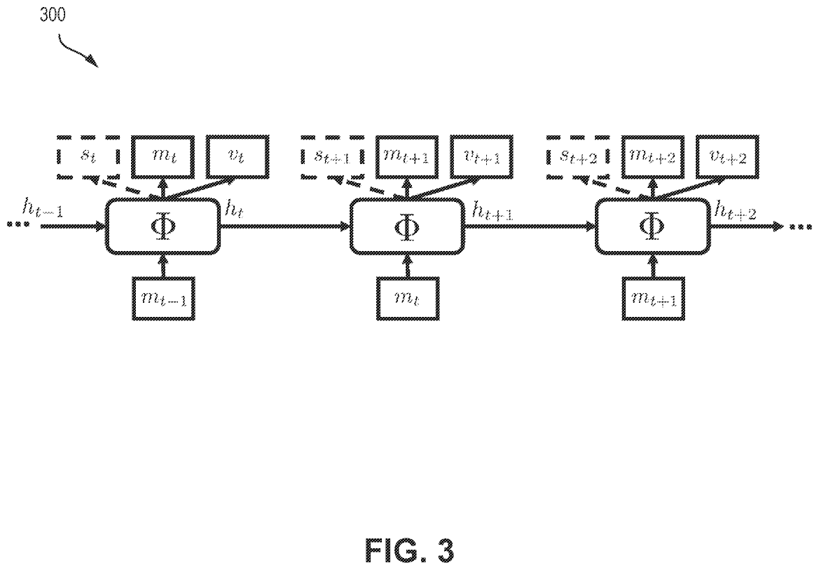

As shown in FIG. 3, which illustrates an example recurrent neural network model 300 for probabilistic forecasting in AR, a selection value s_{i,t} may be associated with a respective probabilistic forecasting prediction at each time step or timestamp t. In some embodiments, the RNN model 300 may be an example of neural network 110.

Therefore, the conditional likelihood in Eq. (3) can be rewritten as,

$$\frac{1}{N} {\sum }_{i = 1}^{N} {\prod }_{t = 1}^{{T}^{f}} 𝒫 ( {y}_{i , t}^{f} \vert {m}_{i , t} , {v}_{i , t} ) , \qquad ( 5 )$$

and the negative log likelihood (NLL) can be used as the loss function for probabilistic forecasting,

$$N LL ( {Y}_{i}^{f} \vert {Y}_{i}^{c} ; Φ ) = \frac{1}{N} {\sum }_{i = 1}^{N} \frac{{\sum }_{t = 1}^{{T}^{f}} - log ( 𝒫 ( {y}_{i , t}^{f} \vert {m}_{i , t} , {v}_{i , t} ) )}{{T}^{f}} . \qquad ( 6 )$$

In some embodiments, the overall learning objective of a baseline model [symbol] _{base} is set as

[symbol]

_{base}=NLL. (7)

In some embodiments, neural network 110 may be updated by the select/reject engine 114, which can output a selection value s_{i,t}∈(0,1),

m_{i,t+1},v_{i,t+1},s_{i,t+1},h_{i,t+1}=Φ(m_{i,t},h_{i,t};θ), (8)

as shown in FIG. 3.

h_{i,t} represents a hidden state vector at timestamp t for the ith sample; and h_{i,t+1} represents a hidden state vector at timestamp t+1 for the ith sample.

In some embodiments, a weight averaged NLL loss is defined as,

$$WNLL ( {Y}_{i}^{f} \vert {Y}_{i}^{c} ; Φ ) = \frac{1}{N} {\sum }_{i = 1}^{N} \frac{{\sum }_{t = 1}^{{T}^{f}} - {s}_{i , t} log ( 𝒫 ( {y}_{i , t}^{f} \vert {m}_{i , t} , {v}_{i , t} ) )}{{\sum }_{t = 1}^{{T}^{f}} {s}_{i , t}} . \qquad ( 9 )$$

An adjustment can be made to reveal the relations between WNLL and NLL, where WNLL should be less than NLL because of the inclusion of the reject option implemented by the select/reject engine 114,

ADJ=max(0,WNLL(Yᵢ^{f}|Yᵢ^{c};Φ)−NLL(Yᵢ^{f}|Yᵢ^{c};Φ)+β), (10)

which is a hinge loss with margin β≥0. Moreover, s_{i,t} is also bounded with the expected coverage rate τ,

$$C VG = \vert τ - \frac{1}{N \cdot {T}^{f}} {\sum }_{i = 1}^{N} {\sum }_{t = 1}^{{T}^{f}} {s}_{t , i} \vert . \qquad ( 11 )$$

where CVG stands for coverage, and coverage rate can be a user specified value. For example, coverage rate τ can be 90%.

In some embodiments, the overall objective of the neural network 110, denoted by [symbol] ᵣ, is given by

[symbol]

ᵣ=NLL+α·ADJ+λ·CVG. (12)

In some embodiments, the neural network 110 can be configured to generate any prediction in which the output can be a range of values (e.g. probabilistic forecasting). In some embodiments, neural network 110 does not have to be specific to the time domain.

In some embodiments, neural network 110 can be used as a regression problem. In some embodiments, an LSTM or GRU can be substituted with another backbone model.

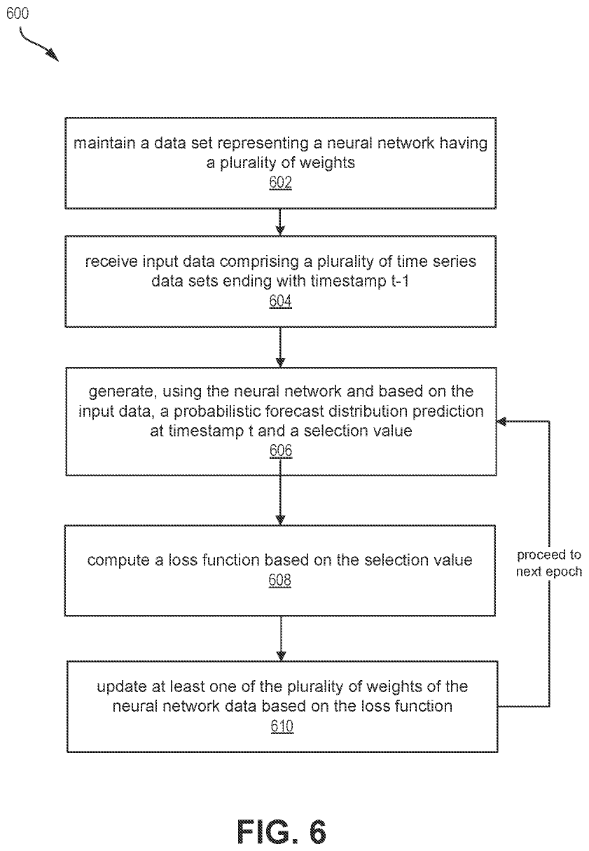

At 504, the processor 104 is configured to train the neural network 110 with input data as described below in connection with FIG. 6. The input data can include a plurality of time series data values.

At 506, the processor 104 is configured to store a data set including data and/or instructions representing the trained neural network 110 and/or any other information required to instantiate, loads, configure or otherwise regenerate the trained neural network 110.

At 508, the processor 104 can input query data to the trained neural network 110 to generate a forecast prediction and an associated selection value. In some embodiments, this can include receiving a request for outputs for one or more inputs (e.g. times). In some embodiments, this can include automatically generating outputs for all possible or defined times.

At 510, the processor 104 is configured to generate signals for communicating an output based on the forecast prediction and the associated selection value. In some embodiments, the signals for communicating the output can cause the output to be display on a display. In some embodiments, the signals for communication the output can send the output to and/or trigger a subsequent data process. In some embodiments, the signals for communication the output can include a message to be sent to a recipient device or destination.

In some embodiments, at inference time, predictions with selection value below a threshold (e.g s_{i,t}<0.5) can be rejected. The threshold may be predetermined by a user, and modified by a user. In some embodiments, the threshold may be determined based on a sigmoid function.

In some embodiments, both the prediction and the selection value can be communicated. In some embodiments, the prediction can be outputted only when the select/reject value indicates the prediction is selected (not rejected).

In some embodiments, the output can be NULL or another value which indicates that the select/reject value indicates the prediction is rejected.

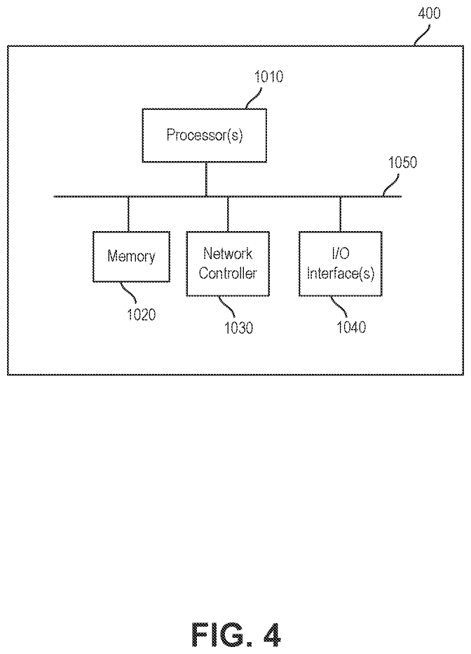

Example process 500 may be implemented as software and/or hardware, for example, in a computing device 400 as illustrated in FIG. 4. Method 500, in particular, one or more of blocks 502 to 510, may be performed by software and/or hardware of a computing device such as computing device 400.

FIG. 4 is a high-level block diagram of computing device 400. Computing device 400, under software control, may monitor a machine learning model.

As illustrated, computing device 400 includes one or more processor(s) 1010, memory 1020, a network controller 1030, and one or more I/O interfaces 1040 in communication over bus 1050.

Processor(s) 1010 may be one or more Intel x86, Intel x64, AMD x86-64, PowerPC, ARM processors or the like.

Memory 1020 may include random-access memory, read-only memory, or persistent storage such as a hard disk, a solid-state drive or the like. Read-only memory or persistent storage is a computer-readable medium. A computer-readable medium may be organized using a file system, controlled and administered by an operating system governing overall operation of the computing device.

Network controller 1030 serves as a communication device to interconnect the computing device with one or more computer networks such as, for example, a local area network (LAN) or the Internet.

One or more I/O interfaces 1040 may serve to interconnect the computing device with peripheral devices, such as for example, keyboards, mice, video displays, and the like. Such peripheral devices may include a display of device 120. Optionally, network controller 1030 may be accessed via the one or more I/O interfaces.

Software instructions are executed by processor(s) 1010 from a computer-readable medium. For example, software may be loaded into random-access memory from persistent storage of memory 1020 or from one or more devices via I/O interfaces 1040 for execution by one or more processors 1010. As another example, software may be loaded and executed by one or more processors 1010 directly from read-only memory.

Example software components and data stored within memory 1020 of computing device 400 may include software to instantiate, train and/or utilize a machine learning architecture, as disclosed herein, and operating system (OS) software allowing for basic communication and application operations related to computing device 120.

FIG. 6 is a flowchart showing aspects of an example process 600 for training a neural network 110 for probabilistic forecasting, which may be performed by system 100.

At step 602, the processor 104 stores or maintains a data set representing the neural network 110 having a plurality of weights. A weight is a parameter within a neural network that transforms input data within the network's hidden layers. Weights are learnable parameters inside the neural network 110. During initialization stage, prior to training, the processor 104 may instantiate a neural network 110 and randomize the weight and bias values thereof.

At step 604, the processor 104 receives input data comprising a plurality of time series data sets ending with timestamp t−1. For example, the plurality of time series data sets may include N time series data sets and be denoted by [symbol] ={Yᵢ}ᵢ₌₁^{N}. The N different time series may contain data of the same type. For example, each of the N different time series may include, respectively, a time series data on historical electricity consumption data for a user or an area.

The temporal length of each sample in the N different time series is the same and denoted as T. Therefore, Yᵢ∈ [symbol] ^{1×T}. By expressing Yᵢ as

Yᵢ=y_{i,1:T},

the sub-sequences of Yᵢ can be easily located. For example, the data of the ith sample between t₁ and t₂ (t₁<t₂) can be represented as y_{i,t}_{₁}_{:t}_{₂}. The data point at a time step t is simplified as y_{i,t}∈ [symbol] . Each sample Yᵢ is further divided into two non-overlapping sub-series: the context series Yᵢ^{c}∈ [symbol] ^{1×T}^{^{c}} and the forecast sequence Yᵢ^{f}∈ [symbol] ^{1×T}^{^{f}}. Specifically,

Yᵢ=[Yᵢ^{c},Yᵢ^{f}],

where Yᵢ^{c}=y_{i,1:T}_{^{c}} and Yᵢ^{f}=y_{i,T}_{^{c}}_{+1:T} with T=T^{C}+T^{f}.

Given the context Yᵢ^{c}, time series forecasting aims to predict the values at future time steps and Yᵢ^{f} serves as the ground-truth of such predictions. Instead of predicting the exact value at each time step of Yᵢ^{f}, the neural network 110 may implement the probabilistic forecasting to estimate the likelihoods of the forecast values at a given time stamp, such as at time t, based on input data ending with timestamp t−1.

At step 606, the processor 104 generates, using the neural network 110 and based on the input data, a probabilistic forecast distribution prediction at timestamp t and a selection value associated with the probabilistic forecast distribution prediction at timestamp t, as described above.

In some embodiments, the probabilistic forecast distribution prediction at timestamp t may include a mean and a variance of the probabilistic forecast distribution prediction.

In some embodiments, the neural network 110 may be a recurrent neural network (RNN) represented by Φ based on:

m_{i,t+1},v_{i,t+1},s_{i,t+1},h_{i,t+1}=Φ(m_{i,t},h_{i,t};θ), where:

m_{i,t+1} represents a mean value of the probabilistic forecast distribution prediction at timestamp t+1 for the ith sample; v_{i,t+1} represents a variance v_{i,t+1} of the probabilistic forecast distribution prediction at timestamp t+1 for the ith sample; s_{i,t+1} represents the selection value associated with the probabilistic forecast distribution prediction at timestamp t+1 for the ith sample; m_{i,t} represents a mean value of a probabilistic forecast distribution prediction at timestamp t for the ith sample; θ represents one or more learnable model parameters (e.g., weights and/or bias) for the recurrent neural network; h_{i,t} represents a hidden state vector at timestamp t for the ith sample; and h_{i,t+1} represents a hidden state vector at timestamp t+1 for the ith sample.

At step 608, the processor 104 computes a loss function based on the selection value. For example, the loss function may be denoted by [symbol] ᵣ=NLL+α·ADJ+λ·CVG, where:

$$N LL ( {Y}_{i}^{f} \vert {Y}_{i}^{c} ; Φ ) = \frac{1}{N} {\sum }_{i = 1}^{N} \frac{{\sum }_{t = 1}^{{T}^{f}} - log ( 𝒫 ( {y}_{i , t}^{f} \vert {m}_{i , t} , {v}_{i , t} ) )}{{T}^{f}} , \\ WNLL ( {Y}_{i}^{f} \vert {Y}_{i}^{c} ; Φ ) = \frac{1}{N} {\sum }_{i = 1}^{N} \frac{{\sum }_{t = 1}^{{T}^{f}} - {s}_{i , t} log ( 𝒫 ( {y}_{i , t}^{f} \vert {m}_{i , t} , {v}_{i , t} ) )}{{\sum }_{t = 1}^{{T}^{f}} {s}_{i , t}} , ADJ = max ( 0 , WNLL ( {Y}_{i}^{f} \vert {Y}_{i}^{c} ; Φ ) - NLL ( {Y}_{i}^{f} \vert {Y}_{i}^{c} ; Φ ) + β ) , \\ CVG = \vert τ - \frac{1}{N \cdot {T}^{f}} {\sum }_{i = 1}^{N} {\sum }_{t = 1}^{{T}^{f}} {s}_{t , i} \vert .$$

At step 610, the processor 104 updates at least one of the plurality of weights of the neural network 110 based on the loss function. In some embodiments, the loss value determined based on the loss function may be backpropogated through time in order to update the weights of the neural network 110. The neural network 110 is therefore trained by calculating errors from its output layer to its input layer.

After step 610, the processor 104 may proceed to step 606 again, using the most recent output from neural network 110 from the previous training epoch as input for the neural network 110, as shown in FIG. 3. This may continue until a predetermined number of training epoch has finished, until training input data has been exhausted, or until the loss value determined by the loss function has reached a certain threshold. In some embodiments, within one epoch, the loss for each time series in the training dataset has been computed once, i.e. cycled i from 1 to N.

In some embodiments, when the selection value is higher than or equal to a threshold value, the processor 104 stores the probabilistic forecast distribution prediction at timestamp t as a valid prediction.

In some embodiments, the processor 104 is configured to process the stored probabilistic forecast distribution prediction at timestamp t to generate a predicted electricity consumption report that may be used to generate pricing prediction for electricity.

In some embodiments, the processor 104 is configured to process the stored probabilistic forecast distribution prediction at timestamp t to generate a future financial forecasting statement.

In some embodiments, when the selection value is lower than a threshold value, the processor 104 is configured to reject the probabilistic forecast distribution prediction at timestamp t.

In some embodiments, the processor 104 is configured to generate a signal for causing, at a display device, a display of a graphical user interface showing that the probabilistic forecast distribution prediction at timestamp t has been rejected.

In some embodiments, the processor 104 is configured to generate a second signal for causing, at the display device, a display of a graphical user interface showing the threshold value and optionally a graphical user element for modifying the threshold value. The graphical user element may be, for example, a user field configured to receive a user input as an updated value for the threshold.

### Practical Application and Experimental Data

An electricity dataset (https://github.com/laiguokun/multivariate-time-series-data) contains the hourly-based electricity consumption of 321 different users in three consecutive years (from 2012 to 2014). In one test, the time series data is split into three portions according to the years and apply a three-fold cross-validation. Two years' data is used to train and validate. The remaining one year is kept out for testing. 25% of the training samples are kept out as validation set. The time series data are standardized with the train split statistics of corresponding users. Each data sample is a time series of a user and consists of data points among 8 consecutive days. It is further divided into two parts, as in Eq. (2). The subsequence of the first 7 days (168 hours/data-points) is the context sequence while the remaining 1 day (24 hours/data-points) is the prediction sequence. The prediction sequence is the ground-truth of time series forecasting.

In some embodiments, an example baseline model is trained with NLL loss only. Selection may be performed as a post-processing rule, by applying a threshold on the predicted variance v_{i,t}. By setting the expected coverage rate τ∈(0,1], the global threshold on variance is the largest 1−τ of all predicted variances v_{i,t} in the validation set. As an alternative, user-specific thresholds may be determined based on the validation set.

Moreover, the baseline model is tested under an optimistic “oracle” selection rule. In some example embodiments, the τ-confidence interval is computed based on the distribution parameters m_{i,t}, v_{i,t}. The prediction can then be selected when the ground truth falls within the confidence interval, and reject it otherwise. This is an upper bound of performance given the baseline model, as it can assume perfect or near perfect knowledge of the ground truth.

In some embodiments, Gated Recurrent Units (GRU) is used as the sequential model with one hidden layer. Its hidden dimension is set to 64. The pre-defined distribution [symbol] is Laplacian. During training, for the proposed loss [symbol] ᵣ (Eq. (12)), α=λ=1.0. The expected coverage rate τ=0.9 for CVG loss. The learning rate is set to 0.001 with ADAM optimizer used for 10 epoch training. During evaluation and testing, the confidence rate is also set to 0.9 for the learned baseline model.

### Results

The testing results on electricity dataset are in Table 1.

TABLE 1
Testing results on electricity dataset.

| | NLL | R-NLL | Coverage |
|---|---|---|---|
| [symbol] _{base} with oracle selection | 0.25 | 0.06 | 0.93 |
| [symbol] _{base} with user thresholds | 0.25 | 0.17 | 0.91 |
| [symbol] _{base} with global threshold | 0.25 | 0.13 | 0.93 |
| [symbol] ᵣ | 0.19 | 0.08 | 0.89 |

NLL means the negative log likelihood value on all testing predictions and ground-truths. R-NLL is the NLL losses on the remaining data after reject process. Coverage is the coverage rate of non-rejected forecast predictions.

In the above example scenario, the model base in [symbol] ᵣ as described herein performed better than the previous [symbol] _{base} approaches, as lower NLL indicates better performance.

The methods and models described herein can be used for other probabilistic forecasting applications. For example, example embodiments could be applied to financial data sets to generate a range of predicted amounts of money will be spent by a customer in a given month (with the associated selection values). In some applications, embodiments can be used to predict cash flows (e.g. incoming, outgoing), amounts of individual bills/transactions, financial summaries, micro level transactions/cash flows, and/or other budgeting or financially-related predictions.

In some situations, in contrast to post-processing approaches in which previous models did not know they had a reject option, aspects of the present application can provide a neural network model which can reject (or learn to reject during training). In some situations, this may improve training as time and resources may not have to be spent trying to fit hard examples.

It should be understood that steps of one or more of the blocks depicted in FIG. 6 may be performed in a different sequence or in an interleaved or iterative manner. Further, variations of the steps, omission or substitution of various steps, or additional steps may be considered.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

1. A computer-implemented system for training a neural network for probabilistic forecasting, the system comprising:
at least one processor;
memory in communication with the at least one processor;
instructions stored in the memory, which when executed at the at least one processor causes the system to:
maintain a data set representing a neural network having a plurality of weights;
receive input data comprising a plurality of time series data sets ending with timestamp t−1;
generate, using the neural network and based on the input data, a probabilistic forecast distribution prediction at timestamp t and a selection value associated with the probabilistic forecast distribution prediction at timestamp t;
compute a loss function based on the selection value; and
update at least one of the plurality of weights of the neural network based on the loss function.

2. The system of claim 1, wherein the probabilistic forecast distribution prediction at timestamp t comprises a mean and a variance of the probabilistic forecast distribution prediction.

3. The system of claim 1, wherein the instructions when executed at the at least one processor causes the system to:
when the selection value is higher than or equal to a threshold value, store the probabilistic forecast distribution prediction at timestamp t as a valid prediction.

4. The system of claim 3, wherein the instructions when executed at the at least one processor causes the system to:
process the stored probabilistic forecast distribution prediction at timestamp t to generate a predicted electricity consumption report.

5. The system of claim 3, wherein the instructions when executed at the at least one processor causes the system to:
process the stored probabilistic forecast distribution prediction at timestamp t to generate a future financial forecasting statement.

6. The system of claim 1, wherein the instructions when executed at the at least one processor causes the system to:
when the selection value is lower than a threshold value, reject the probabilistic forecast distribution prediction at timestamp t.

7. The system of claim 6, wherein the instructions when executed at the at least one processor causes the system to:
generate a signal for causing, at a display device, a display of a graphical user interface showing that the probabilistic forecast distribution prediction at timestamp t has been rejected.

8. The system of claim 7, wherein the instructions when executed at the at least one processor causes the system to:
generate a second signal for causing, at the display device, a display of a graphical user interface showing the threshold value.

9. The system of claim 8, wherein the instructions when executed at the at least one processor causes the system to:
generate a third signal for causing, at the display device, a display of a graphical user interface showing a graphical user element for modifying the threshold value.

10. The system of claim 1, wherein the neural network comprises a recurrent neural network (RNN) represented by Φ based on:
m_{i,t+1},v_{i,t+1},s_{i,t+1},h_{i,t+1}=Φ(m_{i,t},h_{i,t};θ), wherein:
m_{i,t+1} represents a mean value of the probabilistic forecast distribution prediction at timestamp t+1 for the ith sample;
v_{i,t+1} represents a variance v_{i,t+1} of the probabilistic forecast distribution prediction at timestamp t+1 for the ith sample;
s_{i,t+1} represents the selection value associated with the probabilistic forecast distribution prediction at timestamp t+1 for the ith sample;
m_{i,t} represents a mean value of a probabilistic forecast distribution prediction at timestamp t for the ith sample;
θ represents one or more learnable model parameters for the recurrent neural network;
h_{i,t} represents a hidden state vector at timestamp t for the ith sample; and
h_{i,t+1} represents a hidden state vector at timestamp t+1 for the ith sample.

11. A computer-implemented method for training a neural network for probabilistic forecasting, the method comprising:
maintaining a data set representing a neural network having a plurality of weights;
receiving input data comprising a plurality of time series data sets ending with timestamp t−1;
generating, using the neural network and based on the input data, a probabilistic forecast distribution prediction at timestamp t and a selection value associated with the probabilistic forecast distribution prediction at timestamp t;
computing a loss function based on the selection value; and
updating at least one of the plurality of weights of the neural network
based on the loss function.

12. The method of claim 11, wherein the probabilistic forecast distribution prediction at timestamp t comprises a mean and a variance of the probabilistic forecast distribution prediction.

13. The method of claim 11, further comprising:
when the selection value is higher than or equal to a threshold value, storing the probabilistic forecast distribution prediction at timestamp t as a valid prediction.

14. The method of claim 13, further comprising:
processing the stored probabilistic forecast distribution prediction at timestamp t to generate a predicted electricity consumption report.

15. The method of claim 13, further comprising:
processing the stored probabilistic forecast distribution prediction at timestamp t to generate a future financial forecasting statement.

16. The method of claim 11, further comprising:
when the selection value is lower than a threshold value, rejecting the probabilistic forecast distribution prediction at timestamp t.

17. The method of claim 16, further comprising:
generating a signal for causing, at a display device, a display of a graphical user interface showing that the probabilistic forecast distribution prediction at timestamp t has been rejected.

18. The method of claim 17, further comprising:
generating a second signal for causing, at the display device, a display of a graphical user interface showing the threshold value and a graphical user element for modifying the threshold value.

19. The method of claim 11, wherein the neural network comprises a recurrent neural network (RNN) represented by Φ based on:
m_{i,t+1},v_{i,t+1},s_{i,t+1},h_{i,t+1}=Φ(m_{i,t},h_{i,t};θ), wherein:
m_{i,t+1} represents a mean value of the probabilistic forecast distribution prediction at timestamp t+1 for the ith sample;
v_{i,t+1} represents a variance v_{i,t+1} of the probabilistic forecast distribution prediction at timestamp t+1 for the ith sample;
s_{i,t+1} represents the selection value associated with the probabilistic forecast distribution prediction at timestamp t+1 for the ith sample;
m_{i,t} represents a mean value of a probabilistic forecast distribution prediction at timestamp t for the ith sample;
θ represents one or more learnable model parameters for the recurrent neural network;
h_{i,t} represents a hidden state vector at timestamp t for the ith sample; and
h_{i,t+1} represents a hidden state vector at timestamp t+1 for the ith sample.

20. A non-transitory computer readable memory having stored thereon a data set representing a neural network and instructions for training the neural network, the instructions, when executed at the at least one processor, causes a system having the at least one processor to:
maintain the data set representing the neural network having a plurality of weights;
receive input data comprising a plurality of time series data sets ending with timestamp t−1;
generate, using the neural network and based on the input data, a probabilistic forecast distribution prediction at timestamp t and a selection value associated with the probabilistic forecast distribution prediction at timestamp t;
compute a loss function based on the selection value; and
update at least one of the plurality of weights of the neural network based on the loss function.
